(19) United States
(12) Patent Application Publication
(10) Pub. No.: US 2006/0098598 A1
(43) Pub. Date: May 11, 2006

(54) Seamless transitions of active calls between enterprise telecommunications networks and licensed public telecommunications networks

(76) Inventor: Michael Gallagher, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/029,947

(22) Filed: Jan. 4, 2005

Related U.S. Application Data
(60) Provisional application No. 60/626,775, filed on Nov. 10, 2004.

(51) Int. Cl. H04Q 7/00

(52) U.S. Cl. 370/331

(57) ABSTRACT

Seamless transitions between an enterprise telephony system and a licensed public telecommunications system are described. In one embodiment, the invention includes receiving through a private telephony switch a request from a mobile station to handover an active call, the active call being between the private telephony switch and the mobile station, establishing a wireless channel between the private telephony switch and the mobile station through a base station of a wireless licensed telecommunications system, and transferring the active call to the established wireless channel

### CROSS-REFERENCE TO RELATED APPLICATIONS

This application claims the benefit of U.S. Provisional Application Ser. No. 60/626,775, entitled “System and Method for Integrating Enterprise and Cellular Telecommunications Services,” filed Nov. 10, 2004.

### TECHNICAL FIELD

This invention relates generally to telecommunications. More particularly, this invention relates to a technique for seamlessly integrating voice and data telecommunication services across a licensed wireless system, for example a public cellular telephone system, and an unlicensed wireless system, for example an enterprise voice over IP wireless exchange.

### BACKGROUND OF THE INVENTION

Licensed wireless telecommunications systems provide mobile wireless communications to users mobile transceivers. Licensed wireless systems may be public cellular telephone systems, Personal Communication Services (PCS) telephone systems, or other types of mobile telecommunications systems. Wireless transceivers may include cellular telephones, PCS telephones, wireless-enabled personal digital assistants, wireless modems, etc.

Licensed wireless systems use wireless signal frequencies that are licensed from governments, quasi-governmental agencies, or other official licensing agencies. Large fees may be paid for access to these frequencies or there may be complex application procedures making the frequency resources expensive and scarce. In a cellular telephone and data system, expensive base station equipment is used to support communications on licensed frequencies. So the number of base stations and the amount of frequency bandwidth allocated to each use is limited by the cost of obtaining frequencies and installing transceivers. As a result, the quality of service (voice quality and speed of data transfer) in licensed wireless systems may be considerably less than the quality of service provided by landline (wired) connections.

Landline (wired) connections are extensively deployed and generally perform at a lower cost with higher quality voice and higher speed data services. The problem with landline connections is that they constrain the mobility of a user. Traditionally, a physical connection to the landline is required. Enterprises may implement a landline telecommunications system with a telephone switch, such as a PBX (Private Branch Exchange) and a number of wired subscriber units, such as desk telephones. An IP (Internet Protocol) PBX may integrate the telephone network with a data network and communicate voice and data over one wired network. Additional switches may be used for additional user terminals or to connect with additional sites.

Unlicensed frequencies may be used to provide mobility to wired users in the landline network. Unlicensed radios are typically low power and short range to avoid interference with neighboring unlicensed radios. The lack of licensing costs and the low power of the radios greatly reduce the cost as compared to, for example a cellular telephone system. Due to the large amount of frequency spectrum available in unlicensed systems and the low power of the radios, common unlicensed telecommunications systems offer higher quality of service than, for example, cellular telephone or data modem service. Most current systems, such as WiFi, WLAN (wireless local area network), Bluetooth PAN (Personal Area Networks), and IEEE (Institute of Electrical and Electronics Engineers) 802.11 systems, provide a modest range from a base station and do not support fast moving mobile stations. Wireless LANs are used with an IP PBX to communicate telephone voice signals over the wireless data network through wireless IP telephones.

In order to use high quality low cost unlicensed telecommunications when possible and high cost, high mobility, low quality, licensed telecommunication when necessary, a user must use two mobile stations. If a user has an active call on one system and then moves out of range of one system or into range of the other system, the user must stop the call on the one system and then start a new call on the other system. Two different telephone numbers or NIC (Network Interface Card) addresses are also required. This increases expense and inconvenience for the user.

### BRIEF DESCRIPTION OF THE FIGURES

The invention may be more fully appreciated in connection with the following detailed description taken in conjunction with the accompanying drawings, in which like reference numerals refer to corresponding parts throughout the several views of the drawings, and in which:

FIG. 1 is a block diagram of an enterprise communications network coupled to a cellular communications network according to an embodiment of the present invention;

FIG. 2 is a block diagram of a user terminal according to an embodiment of the present invention;

FIG. 3 is a block diagram of an interworking facility according to an embodiment of the present invention;

FIG. 4 is a flow diagram of handing over an active call from an unlicensed wireless system to a licensed wireless system from the perspective of an interworking facility according to an embodiment of the present invention;

FIG. 5 is a flow diagram of handing over an active call from an unlicensed wireless system to a licensed wireless system from the perspective of a mobile station according to an embodiment of the present invention;

FIG. 6 is a diagram of messages for handover from an enterprise system to a licensed communications system according to an embodiment of the present invention; and

FIG. 7 is a diagram of messages for handover from a licensed communications system to an enterprise system according to an embodiment of the present invention.

### DETAILED DESCRIPTION

An unlicensed wireless enterprise communication system may be seamlessly connected to a licensed wireless system, so that a user may move from one system to the other without interruption. The unlicensed wireless system may be a short-range wireless voice or data system or both that covers an office, an office suite, a building or a campus using a wireless network and a switch to establish circuit switched or packet switched connections between subscribers on the network and with external devices. The external connection may be to the PSTN (Public Switched Telephone Network), the Internet, a WAN (Wide Area Network) or any other external connection.

A mobile station for the unlicensed wireless system may be, for example, a wireless telephone, a smart phone, a personal digital assistant, or mobile computer with a built-in or attached radio or wireless NIC. The mobile station may also support a fixed wireless device that resembles a conventional desk phone or cordless base station.

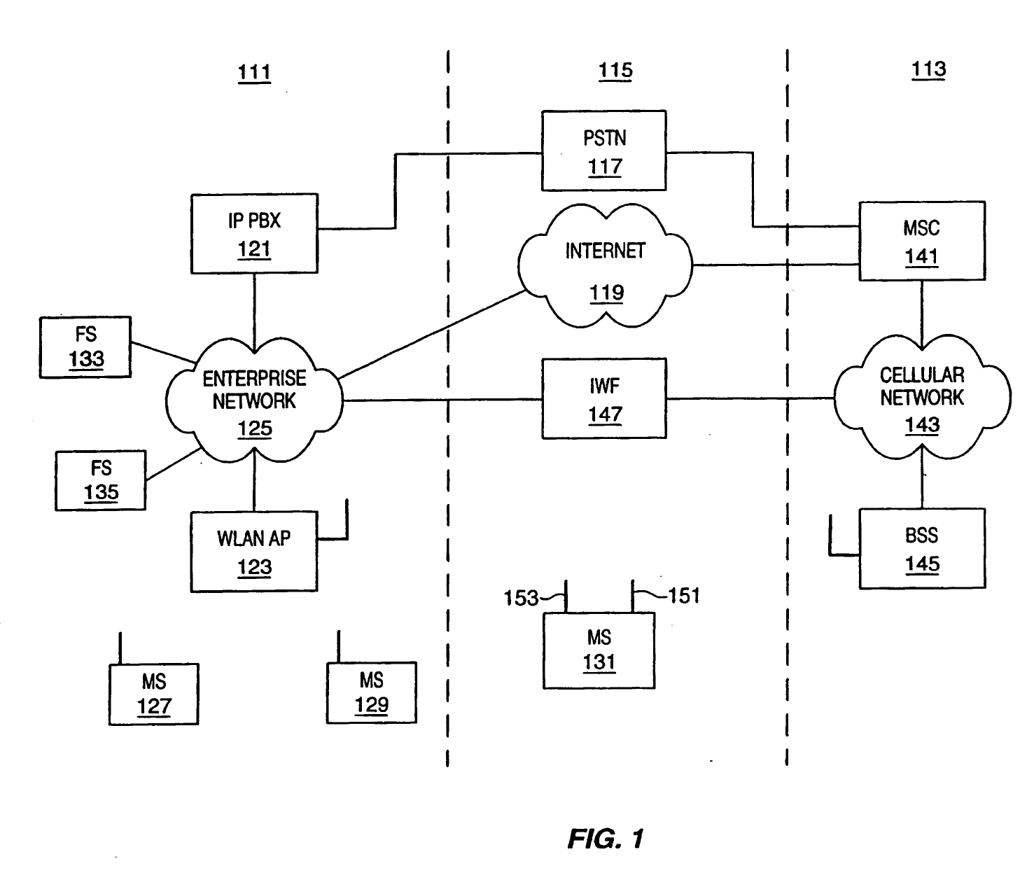

FIG. 1 shows a simplified block diagram of unlicensed and licensed telecommunications systems in proximity to each other. On the left side of the diagram is an enterprise system 111 and on the right side of the diagram is a licensed wireless system such as a cellular telephone network 113. In between the enterprise domain and the cellular domain is a transitional domain 115 in which a user may have access to both networks. The PSTN (Public Switched Telephone Network) 117 and the Internet 119 are also shown as between the two domains. Both systems may be coupled to the PSTN, to the Internet or to both to allow voice and data user to communicate outside their respective networks.

The three domains of FIG. 1 are conceptual signaling and traffic domains and do not necessarily correspond to physical space. A radio located in any one domain may be able to receive transmissions from either the enterprise domain or the public domain. In some implementations, the enterprise domain may have a radio system sufficient to cover a building and its parking lot, while the public domain may also cover the same building and parking lot. In such a case, the radio coverage overlaps completely. It is not necessary to the invention that the radio coverage overlap nor that it be separate.

In the example of FIG. 1, the enterprise telecommunications system 111 has an IP PBX 121 and a WLAN (Wireless Local Area Network) AP (Access Point) coupled together through an enterprise network 125. The enterprise network may be a data network, a voice network or both. The IP PBX may be used to establish circuit switched connections, packet switched connections or both among subscribers on the network. In one embodiment, the enterprise network is a data packet network, such as a CSMA/CD (Carrier Sense Multiple Access with Collision Detection) network, such as Ethernet. The IP PBX uses the data network to establish packet switched voice connections that carry voice traffic over the network in a VoIP (Voice over Internet Protocol) format.

MSs (Mobile Station) 127, 129, 131 may communicate with the WLAN AP through radio, voice, or data channels. The MSs may take any of a variety of different forms suitable for the intended application. Some possible forms include a cellular telephone, a cordless telephone, a personal digital assistant and a portable computer with a radio interface. The enterprise network may support all of these forms and more in order to meet the needs of different subscribers in the enterprise. The enterprise network may also support FS (Fixed Station) terminals 133, 135. The fixed stations may be in the form of a desktop telephone, a desktop computer terminal or a control center.

The radio channel may also take a variety of different forms. In the example of FIG. 1, the radio channels are those typical for WLAN applications, most commonly a version of IEEE 802.11, such as 802.11 g, often referred to as WiFi, or a variation on such a standard such as AirPort Extreme. Other wireless data or voice network channels may be used instead such as Bluetooth PAN (Personal Area Network), a PCS (Personal Communication System) standard or any other wireless voice or radio network. The particular choice of radio channel is not essential to the present invention.

Through the IP PBX, any one of the stations, fixed or mobile, may request a connection to any one or more other stations. So for example, a FS 133 user may dial a three-digit extension corresponding to a MS 127 user. The FS sends the three digit extension as a connection request to the IP PBX which polls the intended MS. The user at the intended MS may hear a ringing tone and can respond by picking up a handset or pushing a talk or answer button. If the user at the intended MS indicates that the user or the MS is available, then the IP PBX establishes a connection and the two terminals communicate through the enterprise network, with or without further involvement by the IP PBX.

The right side of FIG. 1 shows a simplified block diagram of a licensed wireless public telecommunications system, such as a cellular telephone network. The licensed wireless telecommunications system may take any of a variety of different forms. In the example of FIG. 1, a MSC (Mobile Switching Center) 141 is coupled through a cellular network 143 to a BSS (Base Station Subsystem) 145. Typically there will be several MSCs in the cellular network and several BSSs for each MSC. Each BSS may include a BSC (Base Station Controller) coupled to several BTSs (Base Transceiver Station). The cellular network may be a national, international, or local.

The particular design of the network will depend upon many different factors and in many situations there will be several different licensed wireless public telecommunications systems that overlap in the same area. These system may use different and incompatible wireless interfaces. In many metropolitan areas of the United States, there may be a dual-mode AMPS/DAMPS (Advanced Mobile Phone System/Digital AMPS), network, a GSM (Global System for Mobile Communications) network, including GPRS (GSM Packet Radio Service), a PCS (Personal Communication System) network, and a CDMA/UMTS (Code Division Multiple Access/Universal Mobile Telephone Service) network all covering the same physical area. Different carriers may operate on the same interface and other interfaces may be introduced as they are developed. In other locations, other interfaces may alternatively be used, such as PHS (Personal Handyphone System) or other public and proprietary interfaces. Any one or more of these system may be used with the present invention.

Between the Enterprise network 125 and the cellular network 143, FIG. 1 shows an interworking function (IWF) 147. The interworking function may be located with the enterprise domain 111, for example, it may be collocated with or be a part of the IP PBX, a router or other network device. It may also be an independent device on the enterprise network. Alternatively, the IWF may be integrated into the cellular network at the MSC, at a BSS or as a separate device. The IWF is shown as coupled directly to the enterprise network 125 and the cellular network 143, however other connections are also possible. For example, the IWF may connect to the enterprise domain 111 or the public wireless domain 113 or both through the Internet 119 or even through the PSTN 117.

A MS may be able to wander away from the enterprise domain 111. FIG. 1 provides an example of a MS 131 with a radio 153 for the enterprise domain WLAN AP and another radio 151 for the public wireless domain 113. Such a MS may be able to wander freely between all three domains and still have access to communications through the appropriate radio. Embodiments of the present invention may be used to allow the user to wander between the different domains and maintain an active call with no apparent interruption in service. The different domains appear to be seamless as the active call is handed off from one system to the other and back again as the user moves between the three domains.

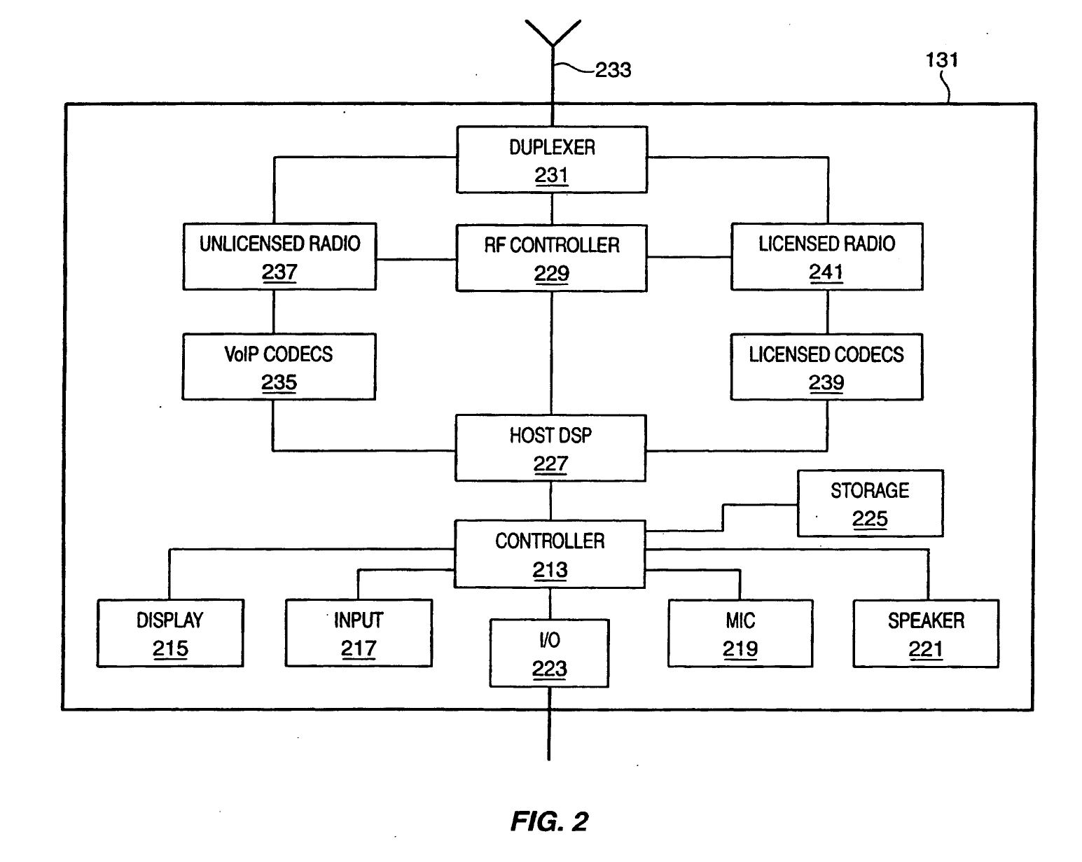

FIG. 2 shows an example of a MS 131 that may be used according to some embodiments of the present invention. The MS of FIG. 2 may be in a form that resembles a dual mode cellular telephone, a cordless telephone, a PDA, a portable computer or a communications card in a larger computer. The functions of the MS are managed by a controller 213 that is coupled to a display 215, a user input device 217, a microphone 219 and a speaker 221. While these components are shown as incorporated into the MS, as may be done for example in a dual mode portable telephone, one or more of the components may be external. The microphone and speaker may be in an external wired or wireless headset or handset, the input device may be an external pointing device or keyboard, and the display may be a standalone monitor. External components may be wired to the device or wirelessly attached, as with a WLAN or Bluetooth radio connection. Any one or more of the illustrated user interface components may be removed for particular applications.

The controller may also be coupled to one or more other I/O (Input/Output) devices 223. These may be a synchronization port, an accessory port, a wired network interface, a docking port, a port replicator that permits further external devices to be attached or an interface to a base station. If the MS is adapted for use as a component of a larger computer system, then the display, input, microphone or speaker may be removed in favor of a bus interface 223. The bus interface may be a PC cardbus, PCI (Peripheral Component Interconnect) bus, a USB (Universal Serial Bus), IDE (Integrated Device Electronics), ATA (Advanced Technology Attachment) or other type of bus. The bus interface may be combined with a display 215, such as status LEDs (Light Emitting Diodes) and a speaker 221.

The controller 213 is further coupled to one or more storage devices 225 such as RAM (Random Access Memory), ROM (Read Only Memory), flash memory, a disk drive and an optical drive. The storage may be used to store operating instructions, applications, and data that is communicated with the enterprise and public domains. The controller is also coupled to a host DSP (Digital Signal Processor). The host DSP communicates data with the controller that is to be carried by the radios. The data may represent voice, text, graphics, applications, etc. The host DSP 227 controls the flow of the data to and from the radio and controls the radios themselves through an RF controller 229. The RF controller controls timing, frequencies, and other aspects of the radios.

The MS of FIG. 1 shows two radio paths from a single antenna 233. More radio paths may be used and, if the radio systems are sufficiently similar, then different radio interfaces may be carried by a single path. The antenna is coupled to a duplexer 231 controlled by the RF controller that routes signals from the appropriate system to the appropriate radio. The duplexer may be a passive frequency multiplexer and demultiplexer or it may be an active device. The duplexer is coupled to an enterprise radio 237 capable of communicating in the enterprise domain 111 and to a licensed band radio 241 capable of communicating in the public domain 113.

The radios 237, 241, controlled by the RF controller, may contain amplifiers, frequency converters, multiplexers, demultiplexers, equalizers, analog and digital converters, encoders and decoders, splitters and combiners, spreaders, despreaders and other elements. The radios are each coupled to voice and data codecs 235, 239 which are, in turn, coupled to the host DSP. Data or voice received from the antenna propagates through the duplexer to the appropriate radio, through the codec, to the host DSP and then to the controller for display, output, play or storage. Data or voice to be transmitted follows the opposite path from the controller through the DSP to the appropriate codecs and radio, through the duplexer and the antenna. The particular type of radio and transmission and reception chain may be adapted to suit different applications. More or less components than those shown in FIG. 2 may be used in a MS. The transmit and receive chains may be combined, as shown or separated.

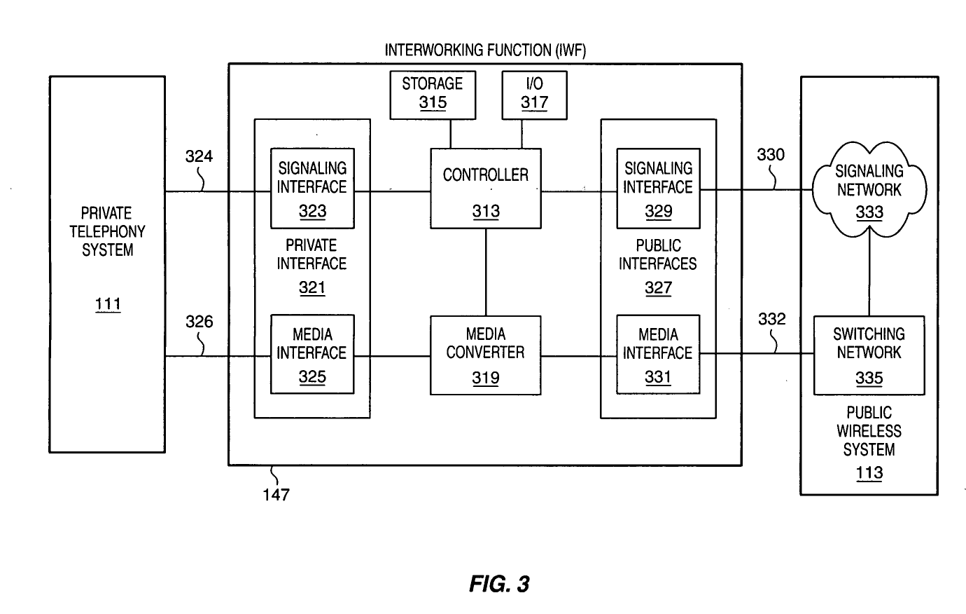

FIG. 3 shows an example of an IWF 147 that may be used according to an embodiment of the invention to seamlessly interconnect a private enterprise telephony system 111 with a licensed public wireless telephony system 113. The IWF has a controller 313 that is coupled to one or more storage devices 315 such as RAM, ROM, flash memory, and disk drives, and to one or more I/O devices 317, such as user interface devices or remote administration and management interfaces. The storage may contain operating and application instructions for the controller as well as data to be communicated by the device.

A private interface 321 is coupled to one or more enterprise systems, such as an IP PBX 121. The interface may be coupled through a dedicated private line, a LAN, a WAN (Wide Area Network), the Internet or through any of a variety of other means. The private interface includes a signaling interface 323 to communicate signaling with the PBX and the user stations, such as handover requests, channel assignments and resource allocations and de-allocation. The signaling interface is coupled through a signaling line 324 which may be a shared connection, such as an IP interface through the Internet or it may be a dedicated connection, such as a private line or a backplane channel.

The private interface also includes a media interface 325 to send and receive traffic with user stations of the enterprise network over a media line 326. The media line may be shared with the signaling line or it may be a separate line. The traffic, as mentioned above, may be voice, text, data ,graphics, applications, instructions and more. In one embodiment, the private interface couples to the enterprise network and, using networking protocols, routes signaling and traffic to the appropriate device, such as the IP PBX or an MS.

Similarly, a public interface 327 is coupled to one or more public communications systems 113. The public interface has a signaling interface 329 for sending signaling over a signaling line 330 to the public system. In one embodiment, the signaling interface converts all signals to the SS7 (Signaling System 7) protocol and transmits them to an SS7 network of the public system. SS7 is used by many licensed public telephony systems. In another embodiment, the signaling interface adapts all signals to a unique protocol used by the particular public telephony system.

The public interface also includes a media interface 331 to carry traffic between the IWF and the public system over a traffic line 332. The public interface may be coupled to TDM (Time Division Multiplexed) trunks, such as T1 lines or any other type of traffic line, depending on the nature of the public system.

Using the two interfaces for each system, the IWF can communicate with each system using protocols and formats that are native to each system. As a result it may not be necessary to perform any modifications to either the enterprise domain or the public domain. A media converter 319 converts traffic between the two formats. Traffic received on the public interface is reformatted for transmission to the private domain through the private interface. Similarly traffic received on the private media interface is converted for transmission to the public domain. Alternatively, these conversions may be performed in the respective interface. Signaling may also be converted by the controller, the interfaces, or a signaling converter (not shown).

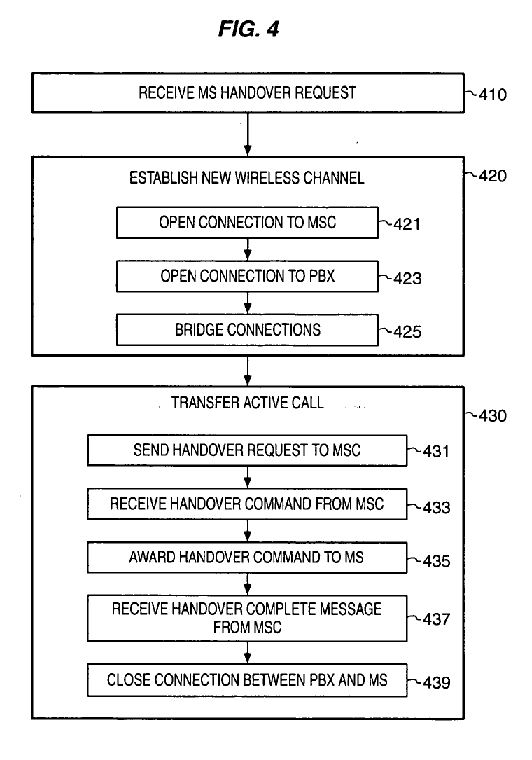

FIG. 4 shows an example of a how an interworking function may handle a seamless handover of a MS from the enterprise system 111 to the public wireless system 113 according to one embodiment of the invention. As shown in FIG. 4, the IWF first receives a handover request from a MS at block 410. In the example of FIG. 4, it may be assumed that the MS is in an active call on the enterprise network. The handover request is a request to hand the active call over from the enterprise network to the public network. Such a handover request may occur when, for example, the user is moving from the enterprise domain 111 to the transitional domain 115 and toward the public domain 113. The MS detects this as the signal for the enterprise domain active call grows weaker and signals from the public network, such as cellular BCH (Broadcast Channel) signals grow stronger. The handover request may be received by the IWF at its private signaling interface through the IP PBX and include information typically required by the public network. This information may include various identification and registration codes, RSSI (Received Signal Strength Indication) measurements made from various public network BCHs and other information.

Upon receiving the handover request, the IWF may establish a wireless channel between the PBX and the MS though a cellular BS (base station) at block 420. The BS is the one that the MS will be handed over to. This connection allow the active call to continue through the PBX to other party on the line through the BS to which the MS will be assigned. The connection may be made in several steps. For example, the IWF may first open a connection using its public signaling interface to a switching center, such as an MSC, of the public network at block 421. The IWF may also open a connection to the IP PBX at block 423 using its private signaling interface. Then the IWF may bridge the two connections at block 425.

With the connections established, the IWF may transfer the active call to the established wireless channel at block 430. This may by done by sending a handover request to the MSC at block 431 through its public signaling interface. The IWF may then receive a handover command in reply from the MSC at block 433 on its public signaling interface. The handover command will typically indicate the BS to which the MS is to be handed over, the traffic channel to be used and other administrative information. The IWF, using its private signaling interface may forward the handover command to the MS through the PBX at block 435. The MS after it acts on the command sends a message to the public system and the IWF may then receive a message from the MSC that handover is complete at block 437. After the call is successfully transferred, the IWF may then close the connection between the PBX and the MS at block 439. During the active call, and while it is being carried by the public domain, the IWF may carry the traffic between the public domain and the private domain through its media interfaces and media converter.

The process of FIG. 4 may also be applied to a handover from the public domain to the private domain. In such a case, the IWF receives the handover request instead through the MSC. The IWF then communicates with the IP PBX to establish a wireless channel between the enterprise network and the MS. After the channel is established, the active call is transferred to the established channel. In both cases, the IWF may appear to the public domain as an MSC. In other words, in such an embodiment, the IWF, using the public system interface, spoofs the protocols that an MSC would use for an inter-MSC handover.

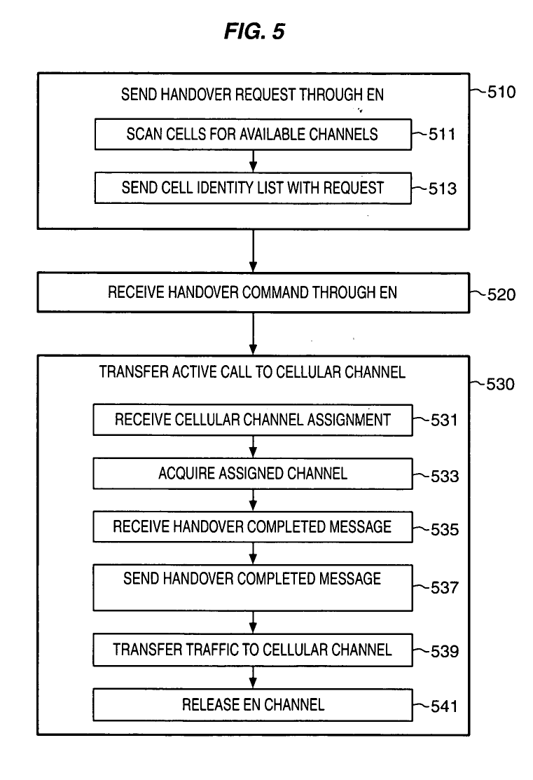

FIG. 5 describes a handover similar to that described above from the perspective of the MS. In brief, the MS sends a handover request through the enterprise network to the IWF at block 510. The MS then receives a handover command through the enterprise network at block 520. Using the handover command, the MS then transfers the active call to the assigned cellular channel at block 530.

In generating the handover request, the MS may typically perform all of the steps that are normally involved in generating a handover request within the public domain. Such steps may include scanning the cellular system for available channels at block 511, and sending a cell identity list with the handover request at block 513 that includes measurements made on signals from different base stations.

At some point after the IWF and MSC have performed their appointed tasks, the MS can transfer its active call. In one embodiment, it will first receive a cellular channel assignment through the enterprise network at block 531. The assigned channel will typically be a traffic channel. It will then acquire the assigned cellular channel at block 533. After sending some signaling on the acquired cellular channel, it will send a completed handover message through that cellular channel at block 535. The MS may then signal the completed handover through the enterprise network to the PBX at block 537. This message will also be received at the IWF. The MS may then transfer its voice traffic to the successfully acquired cellular channel at block 539, and release the enterprise network traffic channel at block 541.

As with the example of FIG. 4, the example of FIG. 5 may be adapted for handovers from the public network to the enterprise network. In such a case, the MS will perform the necessary operations for finding a radio channel on the enterprise network. It may then send a handover request message through the public network. The MSC may interpret this as a request to handover to the IWF which is spoofing protocols that would be used by another MSC. After the IWF, IP PBX and MSC have performed the necessary operations, the MS will receive a handover command from the MSC. It can then transfer the active call from the public domain to an assigned channel in the enterprise network indicated in the handover command.

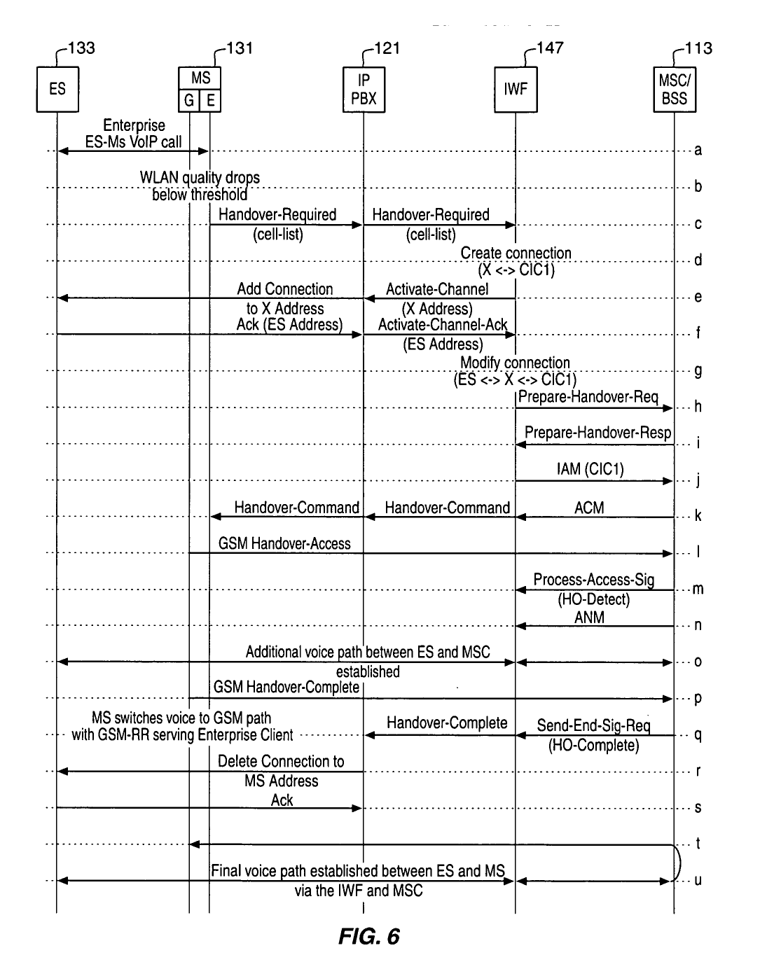

FIG. 6 shows a more complete and detailed sequence of messages that may be exchanged in a seamless handover from an enterprise system to a public system according to an embodiment of the invention. The diagram shows different elements of the enterprise system and the public system across the top row. Arrows between the elements show messages between the elements. Double sided arrows show traffic.

Line a shows an active call as a double sided arrow between an ES (enterprise station), such as a FS 133 or MS as shown in FIG. 1 and the E side of an MS 131. The MS is shown as having two parts labeled as G for a GSM cellular radio section and E for an enterprise radio. In line b, the quality of the WLAN enterprise radio signal drops below some threshold. There are a variety of different way for determining when this occurs. Some systems rely on measurements by the WLAN AP or base station and others use mobile station measurements while other systems may use a combination of both. At line c, the MS signals on its enterprise connection to the IP PBX that a handover is required.

The IP PBX and IWF then set about establishing a channel between the ES and the public network. The IP PBX forwards the handover request to the IWF for further handling. At line d the IWF allocates its own resources and assigns trunk identifiers such as CICs (Carrier Identification Code) to a particular enterprise network address. At line d, the address is sent to the IP PBX which instructs the ES to add this address to its active connections. At line f, the ES acknowledges the connection as established to the IP PBX and the IP PBX informs the IWF. At line g, this established connection is registered by the IWF.

The IWF also establishes a connection to the public domain. At line h, the handover request is sent to the public domain on a signaling channel as a request to prepare a handover. The MSC sees this as a request from another MSC of the system and responds back to the IWF on line i, the response including the handover command which specifies the licensed channel that the BSS has allocated for the handover. On line j, the IWF provides the connection information to the MSC, such as an ISUP (Integrated Services Digital Network User Part) IAM (Initial Address Message). The MSC, after making appropriate provisions to its network, can then reply at line k with the equivalent of an acknowledgement command, such as an ISUP ACM (Address Complete Message). The IWF then forwards the handover command received in line i through the IP PBX to the MS on its enterprise side.

The handover command provides the MS with the information it needs to access the public network. The MS then tunes its public network radio to the assigned channel and sends an access message at line 1 directly to a base transceiver station of the public network. The public network responds with the signals appropriate to establishing the wireless channel between the BTS and the MS (not shown).

When the MSC is signaled that the MS has successfully accessed the public network directly, it can signal the IWF that an access has been detected at line m and provide an ISUP ANM (Answer Message) to complete the ISUP signaling exchange. The IWF and MSC have now established a traffic channel between the ES and the MSC through the IWF media interfaces as shown on line o. Note that in this example, there are now two voice paths between the MS and the ES. The original path through the enterprise network alone is still active. The new path through the IWF to the public domain is also active. Briefly maintaining both paths reduces the chances that the call will be interrupted or dropped.

At line p, the MS has received traffic on the traffic channel from the ES and signals to the public network that the handover is complete. In some public networks, such a signal is sent in-band on the traffic channel. The MSC accordingly signals to the IWF that the handover is complete at line q. The IWF alerts the IP PBX and this allows the enterprise resources to be released.

To release the resources of the original call , the IP PBX signals the ES to delete the original enterprise connection of the active call at line r. The ES acknowledges the message at line s and the final traffic channel is established as shown at line u. The traffic path connects the ES wired or wirelessly through the enterprise network to the IWF and through the media interfaces of the IWF to the MSC. From the MSC, the path is connected through a cellular base station wirelessly to the MS.

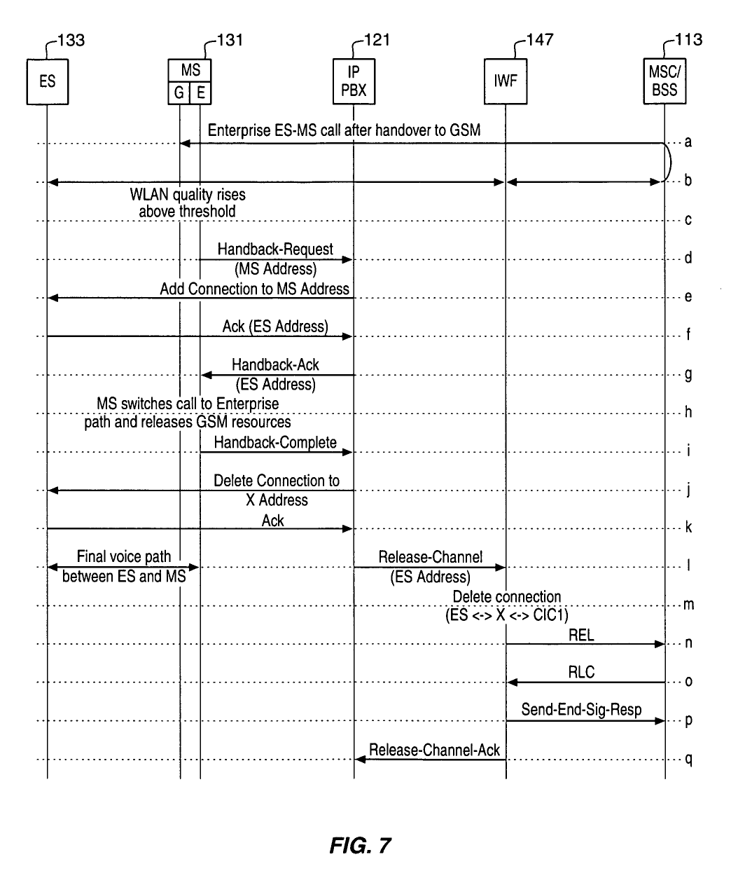

FIG. 7 shows an example of handing an active call over to the enterprise network from the public network. FIG. 7 has the same format as FIG. 6 and the traffic path of lines a and b of FIG. 7 is the same as the traffic path of lines t and u of FIG. 6. The process of FIG. 7 may be performed independently of the process of FIG. 6. One process may be performed before the other and vice versa. From a user's perspective, the MS may allow a call that originated on the public network to be handed over to the enterprise network and it may also allow a call that originated on the enterprise network to be handed over to the public network. Once handed over to one domain it may also be handed back to the original domain and back again as needed to accommodate the movements of the user.

In FIG. 7, the active call is through the public licensed telecommunications service and at line c, the signal quality at the WLAN rises above some threshold. This may be determined by the WLAN AP, by the MS or by both. The MS then signals to the PBX that a handover is requested at line d. Note that in the example of FIG. 7, this message is sent using the enterprise side of the MS after the MS has gained access to the enterprise network. With the MS already on the network, the call can be carried by the enterprise network as soon as a connection is created with the ES.

The IP PBX allocates resources to accommodate the active call within the enterprise network and at line e assigns a new address to the ES that is already active in the call. At line f, the ES acknowledges the signal and at line g, the PBX signals the MS that the connection is complete by acknowledging the handover request. At line h, the MS transfers the traffic of the active call over to the enterprise network as indicated by the traffic path at line 1 .

The MS acknowledges the handover to the PBX at line i and the PBX can then clear unused resources. The PBX signals the ES to release the original connection to the MS at line j. This is acknowledged at line k. The PBX also signals the IWF to release the original connection with the ES at line 1 . The IWF releases internal resources at line m and then signals the MSC to release the connection to the IWF and to the MS at line n. The MSC then signals the IWF to release its channels from the original connection at line o and the IWF acknowledges to the MSC at line p. With the connection through the public network released, the IWF signals its acknowledgment back to the PBX at line q. The active call continues on the one open connection shown on line 1.

The particular sequence of events and types of signals are provided as examples only. The example of FIGS. 6 and 7 are presented in the context of a VoIP IP PBX and a GSM cellular network. Appropriate modifications may be made to comply with other types of networks.

It is to be appreciated that a lesser or more equipped interworking facility, mobile station, enterprise station, enterprise network, and PBX than the examples described above may be desirable for certain implementations. Additional or different components, interfaces, buses and capabilities may be used and additional devices may be added to any of these components. Some of the illustrated components may also be removed from the devices. The configuration of the interworking facility, mobile station, enterprise station, enterprise network and PBX may vary with different implementations depending upon numerous factors, such as price constraints, performance requirements, technological improvements, or other circumstances.

Although the description of the various embodiments refers primarily to transitioning active calls between a VoIP enterprise network and a GSM cellular telecommunications system, the various embodiments may also be used with other types of enterprise communications systems and with other types of public telecommunications networks. The various embodiments may be applied to voice networks, data networks and combined networks whether they are circuit switched or packet switched.

Embodiments of the present invention may be provided as a computer program product which may include a machine-readable medium having stored thereon instructions which may be used to program a control station, a microcontroller or other electronic device to perform a process. The machine-readable medium may include, but is not limited to, floppy diskettes, optical disks, CD-ROMs, and magneto-optical disks, ROM's, RAM's, EPROM's, EEPROM's, magnet or optical cards, flash memory, or other type of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

In the description above, numerous specific details are set forth. However, embodiments of the invention may be practiced without these specific details. For example, well-known equivalent components may be substituted in place of those described herein, and similarly, well-known equivalent techniques may be substituted in place of the particular processes disclosed. In other instances, well-known structures and techniques have not been shown in detail to avoid obscuring the understanding of this description.

While the embodiments of the invention have been described in terms of several embodiments, those skilled in the art will recognize that the invention is not limited to the embodiments described and illustrated, but may be practiced with modification and alteration within the spirit and scope of the appended claims. The description including the drawings is thus to be regarded as illustrative instead of limiting.

1. A method comprising:
receiving through a private telephony switch a request from a mobile station to handover an active call, the active call being controlled by the private telephony switch;
establishing a wireless channel between the private telephony switch and the mobile station through a base station of a wireless licensed telecommunications system; and
transferring the active call to the established wireless channel.

2. The method of claim 1, wherein receiving a handover request comprises receiving a list from the mobile station of the cell identities of the wireless licensed telecommunications system from which the mobile station has received wireless signals.

3. The method of claim 1, wherein establishing a wireless channel comprises sending a handover request to a switching center of the wireless licensed communications system.

4. The method of claim 3, wherein the switching center comprises a mobile switching center (MSC), the method further comprising, after sending a handover request, opening a connection to the MSC using standard licensed communications system methods.

5. The method of claim 3, wherein the handover request emulates a handover request from a switching center of the wireless licensed communications system to another switching center of the wireless licensed communications system.

6. The method of claim 1, wherein establishing a wireless channel comprises opening a connection to the private telephony switch and bridging the connection to the private telephony switch with a connection to the switching center of the wireless licensed communications system.

7. The method of claim 1, wherein establishing a wireless channel comprises sending a handover command to the mobile station through the private telephony switch.

8. The method of claim 1, wherein transferring the active call comprises receiving a handover command from the wireless licensed telecommunications system and forwarding the handover command to the mobile station through the private telephony switch.

9. The method of claim 1, wherein transferring the active call comprises receiving a message from the wireless telecommunications system indicating that the handover is complete and closing the connection between the private telephony switch and the mobile station in response thereto.

10. The method of claim 1, wherein the active call between the private telephony switch and the mobile station is through a wireless unlicensed channel.

11. The method of claim 10, wherein the wireless unlicensed channel is a wireless local area network.

12. The method of claim 1, further comprising sending a message to the mobile station from the private telephony switch through the wireless licensed telecommunications system by wrapping the message in a message format of the wireless licensed telecommunications system.

13. The method of claim 8, wherein the wireless telecommunications system message format comprises a direct transfer application part facility message format.

14. An apparatus comprising:
a first interface to a private telephony switch to receive a request from a mobile station to handover an active call, the active call being controlled by the private telephony switch;
a second interface to a wireless licensed telecommunications system to establish a wireless channel between the private telephony switch and the mobile station through a base station of the wireless licensed telecommunications system; and
a controller to transfer the active call to the established wireless channel.

15. The apparatus of claim 14, wherein the handover request comprises a list of the cell identities of the wireless licensed telecommunications system from which the mobile station has received wireless signals.

16. The apparatus of claim 14, wherein the controller establishes a wireless channel by sending a handover request through the second interface to a switching center of the wireless licensed communications system.

17. The apparatus of claim 16, wherein the switching center comprises a mobile switching center (MSC), the controller further sending the handover request to the MSC using standard licensed communications system methods.

18. The apparatus of claim 16, wherein the handover request emulates a handover request from a switching center of the wireless licensed communications system to another switching center of the wireless licensed communications system.

19. The apparatus of claim 14, wherein the controller establishes a wireless channel by sending a handover command to the mobile station through the first interface.

20. The apparatus of claim 14, further comprising a media converter to receive the handover request from the mobile station through the first interface, convert it, and forward the converted handover request to a switching center through the second interface.

21. The apparatus of claim 14, wherein the media converter further receives a handover command through the second interface converts it and forwards the converted handover command to the mobile station through the first interface.

22. The apparatus of claim 14, wherein the wireless unlicensed channel is a wireless local area network.

23. The apparatus of claim 14, wherein the interface to the private telephony switch is a voice over internet protocol interface.

24. The apparatus of claim 14, wherein the interface to a wireless licensed telecommunications system is a telephony signaling system interface.

25. A method comprising:
sending from a mobile station through an unlicensed wireless network a request to handover an active call, the active call being through the unlicensed wireless network;
receiving a handover command through the unlicensed wireless network to handover the active call from the unlicensed wireless network to an established wireless channel to a base station of a licensed wireless telecommunications system; and
transferring the active call to the established wireless licensed channel.

26. The method of claim 25, wherein sending a handover request comprises sending a list of cell identities of the licensed wireless telecommunications system from which the mobile station has received wireless signals.

27. The method of claim 25, further comprising scanning broadcast channels of the licensed wireless telecommunications system to generate a list of cell identities while simultaneously maintaining the active call using the unlicensed wireless network and wherein sending a handover request comprises sending the list of cell identities.

28. The method of claim 25, wherein establishing a wireless channel comprises the mobile station accessing the licensed wireless telecommunications system while simultaneously maintaining the active call using the unlicensed wireless network.

29. The method of claim 25, wherein establishing a wireless channel comprises the mobile station tuning a wireless radio to an assigned traffic channel of the licensed wireless telecommunications system and detuning a wireless radio from the active call channel on the unlicensed wireless network.

30. The method of claim 25, wherein transferring the active call comprises switching the active call from the unlicensed wireless network connection to the licensed wireless telecommunications system connection and signaling the unlicensed wireless network that the handover is complete.

31. The method of claim 25, wherein transferring the active call comprises receiving a message from the licensed wireless telecommunications system indicating that the handover is complete and closing the unlicensed wireless network connection between the private telephony switch and the mobile station in response thereto.

32. The method of claim 25, further comprising receiving a message from the unlicensed wireless network through the licensed wireless licensed telecommunications system, the message being wrapped in a message format of the licensed wireless telecommunications system.

33. The method of claim 32, wherein the licensed wireless telecommunications system message format comprises a direct transfer application part facility message format.

34. The method of claim 25, wherein the unlicensed wireless network comprises one of a local area network, a wireless hot spot and a personal area network.

35. A mobile station comprising:
a first radio to carry an active call with an unlicensed wireless network;
a second radio to carry an active call with a licensed wireless telecommunications system; and
a controller to cause the second radio to scan for available channels of the licensed wireless telecommunications system and to cause the first radio to send a handover request to handover an active call on the unlicensed wireless network to the licensed wireless telecommunications system based on the results of the scan.

36. The apparatus of claim 35, wherein sending a handover request comprises sending a list of cell identities of the licensed wireless telecommunications system from which the mobile station has received wireless signals during the scan.

37. The apparatus of claim 35, scanning for available channels comprises scanning broadcast channels of the licensed wireless telecommunications system to generate a list of cell identities on the second radio while simultaneously maintaining the active call using the second radio.

38. The apparatus of claim 35 wherein the controller transfers an active call on the first radio to the second radio.

39. The mobile station of claim 38 wherein the controller transfers the active call by causing the second radio to tune to an assigned traffic channel of the licensed wireless telecommunications system and causing the first radio to detune from the active call channel on the unlicensed wireless network.

40. The apparatus of claim 38, wherein the controller causes the first radio to signal the unlicensed wireless network that the handover is complete.

41. The apparatus of claim 38, wherein the controller receives a message on the second radio indicating that the handover is complete and closes the unlicensed wireless network connection between the private telephony switch and the mobile station in response thereto.
